(19) United States
(12) Patent Application Publication
(10) Pub. No.: US 2005/0073728 A1
(43) Pub. Date: Apr. 7, 2005

(54) Movement control apparatus, image scan apparatus and image scanning method

(75) Inventors: Yasunobu Sakaguchi, Kanagawa (JP); Akihiko Erikawa, Kanagawa (JP); Tomonori Nishio, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: Fuji Photo Film Co., Ltd.

(21) Appl. No.: 10/954,226

(22) Filed: Oct. 1, 2004

(30) Foreign Application Priority Data
Oct. 7, 2003 (JP) 2003-348695

(51) Int. Cl. H04N 1/04

(52) U.S. Cl. 358/497

(57) ABSTRACT

A CCD image sensor is fixed on a Y-direction stage that is supported on an X-direction stage. When a piezo driver supplies voltage to an X-direction piezo element and a Y-direction piezo element, the CCD image sensor is moved in X and Y directions. The X-direction position sensor and the Y-direction position sensor detects the position information of the CCD image sensor in X and Y direction respectively, and send the position information to the piezo driver. The piezo driver sets a target movement of the CCD image sensor, and detects the actual movement of the CCD image sensor from the position information. The piezo driver adjusts the output voltage to the X-direction piezo element and the Y-direction piezo element such that the target movement becomes the same as the actual movement.

### BACKGROUND OF THE INVENTION

1. Field of the Invention

The present invention relates to a movement control apparatus for controlling the movement of an object, and an image scan apparatus that has an imaging device to scan an image on a recording medium and the movement control apparatus to move the imaging device.

2. Description of the Related Art

A well-known digital printer scans an image on a recording medium such as a photo film (a negative film and a reversal film, for example) photoelectrically to generate digital image data, and records the image by modulating an intensity of recording light and projecting the recording light on a photosensitive recording material. The digital printer has an advantage in improving the quality of the recorded image by image processing, such as color balance correction and sharpness correction, to the image data of scanned image.

The image on the photo film is scanned by irradiating scan light from a light source and detecting the scan light through the photo film by an area image sensor like an area CCD sensor. For the purpose of increasing the resolution of the scanned image, U.S. Patent Application Publication No. 2001/0021008 describes a technique to repeat to scanning the film image and moving the area image sensor by a predetermined distance about microns (for example, half or quarter of the pixel pitch of the image sensor).

According to the above reference, the area image sensor performs minute movement by applying a voltage to a piezo element to move the area image sensor. Even when the applied voltage to the piezo element is stable, however, the position of the area image sensor is continuously deviated by creeping and hysteresis that are original to the piezo element. Such deviation in the position causes decrease in image quality of the scanned image. Moreover, hysteresis of the piezo element changes the position of the area image sensor at the time when the applied voltage to the piezo element is zero.

In a conventional image scan apparatus, since the movement of the area image sensor is relatively large, the image quality of the scanned image is not affected by the error in the position of the image sensor. When the pixel pitch becomes shorter to reduce the manufacture cost, or when the number to scan a single image increases for the purpose of increasing the resolution of the scanned image, the movement of the image sensor needs to be shorter. In that case, the error in the position of the image sensor affects the quality of the scanned image.

### SUMMARY OF THE INVENTION

An object of the present invention is to provide a movement control device to control the movement of a controlled object like an area image sensor with high precision.

Another object of the present invention is to provide an image scan apparatus and an image scanning method to improve the quality and resolution of the scanned image by repeating to drive such movement control device to move the image sensor and scan the image on the object.

To achieve the above object, the movement control apparatus comprises a moving mechanism for moving a movable stage to support the controlled object, a position detecting device for detecting the position of the movable stage and outputting position information, and a control device for setting target positions of the movable stage including an initial position. The control device controls the movement of the movable stage such that the position information from the position detecting device becomes substantially the same as the target position.

The movable stage is movable in two directions that are perpendicular to each other. The position detecting device is a position sensor that changes the output as the position information in accordance with the distance to the movable stage. The control device sets a target output as an output of the position sensor at the target position, and controls the movement of the movable stage such that the output from the position sensor comes closer to the target output. The moving mechanism may include a piezo element.

In a preferred embodiment, such movement control apparatus is provided with an image scan apparatus for moving an imaging device on a movable stage to plural scan positions and generating image data by photoelectrically scanning an image on a recording medium at the scan positions. The image scan apparatus comprises a moving mechanism for moving the movable stage, a position detecting device for detecting the position of the movable stage and outputting position information, and a control device for setting target positions of the movable stage corresponding to the scan positions. The control device controls the movement of the movable stage such that the position information from the position detecting device becomes substantially the same as the target position. The image scan apparatus comprises an image synthesizing section to combine the image data obtained by image scan at the scan positions.

The scan positions include an initial position to start to scan the image. In addition, the scan positions are arranged at a same interval within the pixel pitch of the imaging device. The scan positions may be randomly shifted from the positions arranged at a same interval within the pixel pitch of the imaging device.

According to the present invention, since the movement of the movable stage is controlled such that the position information from the position detecting device becomes substantially the same as the target position, it is possible to move an object like an area image sensor with high precision. Moreover, controlling the movement of the object at the initial position can prevent the object from being deviated by hysteresis of a moving mechanism such as a piezo element.

### BRIEF DESCRIPTION OF THE DRAWINGS

The above objects and advantages of the present invention will become easily understood by one of ordinary skill in the art when the following detailed description would be read in connection with the accompanying drawings, in which:

FIG. 1 is a schematic view of the structure of a digital printer;

FIG. 2 is an explanatory view of an arrangement of pixels in a CCD image sensor;

FIG. 3 is a schematic view of the structure of a movement control apparatus to move the CCD image sensor;

FIG. 4 is an explanatory view of the scan positions (1st to 8th scan positions) in the image scan operation;

FIG. 5 is a table to show the relative movement of each scan position from the 1st scan position;

FIG. 6 is a graph of output frequency of a position sensor as the function of the gap between the position sensor and a measured object;

FIG. 7 is a block diagram of a feedback control system to control the movement of the CCD image sensor;

FIG. 8 is a flow chart of an image scan operation;

FIG. 9 is a graph of the movement of the CCD image sensor from 1st scan position to 2nd scan position;

FIG. 10 is a graph of the movement of the CCD image sensor from 3rd scan position to 4th scan position;

FIG. 11 is a graph of the movement of the CCD image sensor from 4th scan position to 5th scan position;

FIG. 12 is a graph of the movement of the CCD image sensor from 6th scan position to 7th scan position;

FIG. 13 is a graph of the movement of the CCD image sensor from 1st scan position to 8th scan position in X direction; and

FIG. 14 is a graph of the movement of the CCD image sensor from 1st scan position to 8th scan position in Y direction.

### PREFERRED EMBODIMENTS OF THE INVENTION

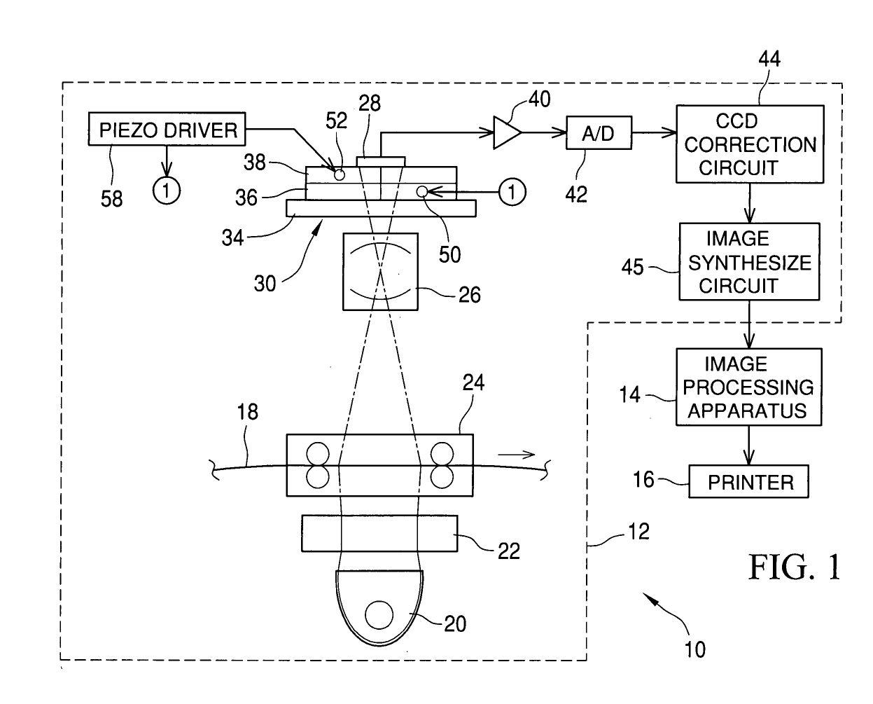

An embodiment according to the present invention is described with reference to the drawings. Referring to FIG. 1, a digital printer 10 comprises an image scan apparatus 12, an image processing apparatus 14 and a printer 16.

The image scan apparatus 12 scans an image on a photo film 18 photoelectrically to convert an optical film image into digital image data while feeding the photo film 18 frame by frame. The image scan apparatus comprises a light source 20, a diffusion box 22, a film carrier 24, a focusing lens 26, a CCD image sensor 28 and a CCD moving mechanism 30.

The light source 20 has LEDs or a lump to irradiate scan light of red, green and blue to the photo film 18. A lump driver and a filter control the amount of the scan light from the light source 20. The light source 20 may irradiate infrared light to detect a scratch or dust on the photo film 18. The scan light is diffused in the diffusion box 22 so that the scan light becomes uniform over the scanned frame of the photo film 18.

The film carrier 24 is removebly mounted on the image scan apparatus 12, and comprises a feeding device to feed the photo film 18 frame by frame in the direction shown by the arrow, a mask to define the scan area of the photo film 18, and a information reader to obtain film information provided with the photo film 18 (such as DX code). The film carrier 24 may set several types of the photo films 18 (135 type and APS type, for example) at the same time. Instead, plural film carrier 24 may be provided for each type of the photo film 18.

The scan light from the light source 20 passes through the image frame on the photo film 18, and is focused on the photo receiving surface of the CCD image sensor 28 by the focusing lens 26. The CCD image sensor photoelectrically converts the scan light from the photo film 18 to obtain image signals corresponding to the image frame on the photo film 18.

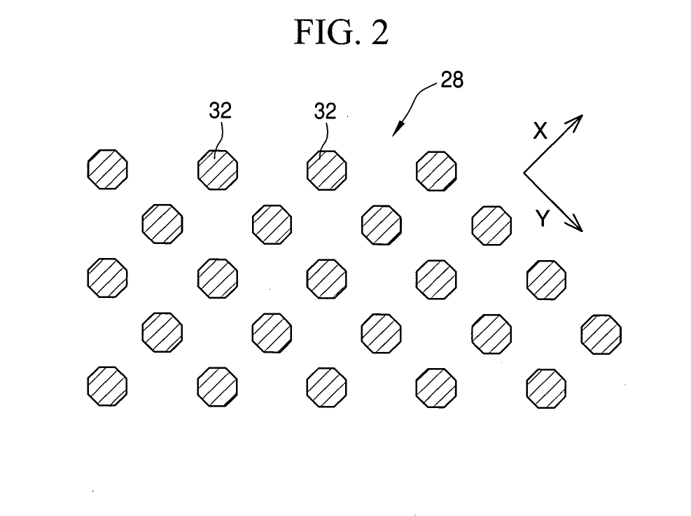

Referring to FIG. 2, the CCD image sensor 28 has plural photo receiving elements 32 each of which corresponds to each of the pixels. The photo receiving elements (pixels) 32 are arranged in hound's-tooth check with respect to the feeding direction of the photo film 18. In other words, the photo receiving elements 32 are arranged to form a honeycomb. Compared with the conventional image sensor with square lattice pixels, the CCD image sensor 28 in this embodiment has higher sensitivity and S/N ratio. In FIG. 1, the CCD image sensor 28 is attached to the CCD moving mechanism 30 that has a support plate 34, an X-direction stage 36 and a Y-direction stage 38. The CCD image sensor 28 is movable in a two dimensional plane parallel to the photo receiving surface of the CCD image sensor 28 by moving the X-direction stage 36 and the Y-direction stage 38. By shifting the CCD image sensor 28, it is possible to carry out so-called pixel shift to increase the resolution of the scanned image.

The image signals output from the CCD image sensor 28 is amplified by an amplifier 40, and then converted to digital image data by an A/D converter 42. The image data of the scanned image is sent to a CCD correction circuit 44 to carry out DC offset correction, shading correction or the like. When the image is repeatedly scanned by use of the pixel shift method, the image data of the scanned image for plural frames is sent to an image synthesize circuit 45 to synthesize the image data. Any known technique is utilized in synthesizing the image data. For instance, the steps for synthesizing the image data by interpolation is described in U.S. Patent Application Publication No. 2001/0021008, entitled “Interpolation Arithmetic Method and Image Reader”, filed on Feb. 9, 2001, the details of which are herein incorporated by reference.

The image data after synthesizing is output to the image processing apparatus 14 to perform various image processing operations such as density correction and gray balance correction. The image processing apparatus 14 converts the image data into print data by use of a LUT (look-up table). The printer 16 modulates the intensity of laser as recording light based on the print data from the image processing apparatus 14, and irradiates modulated laser onto a photosensitive recording material such as a photo paper so that the image is recorded in the recording material. The printer 16 carries out development and fixation processes to obtain a print picture.

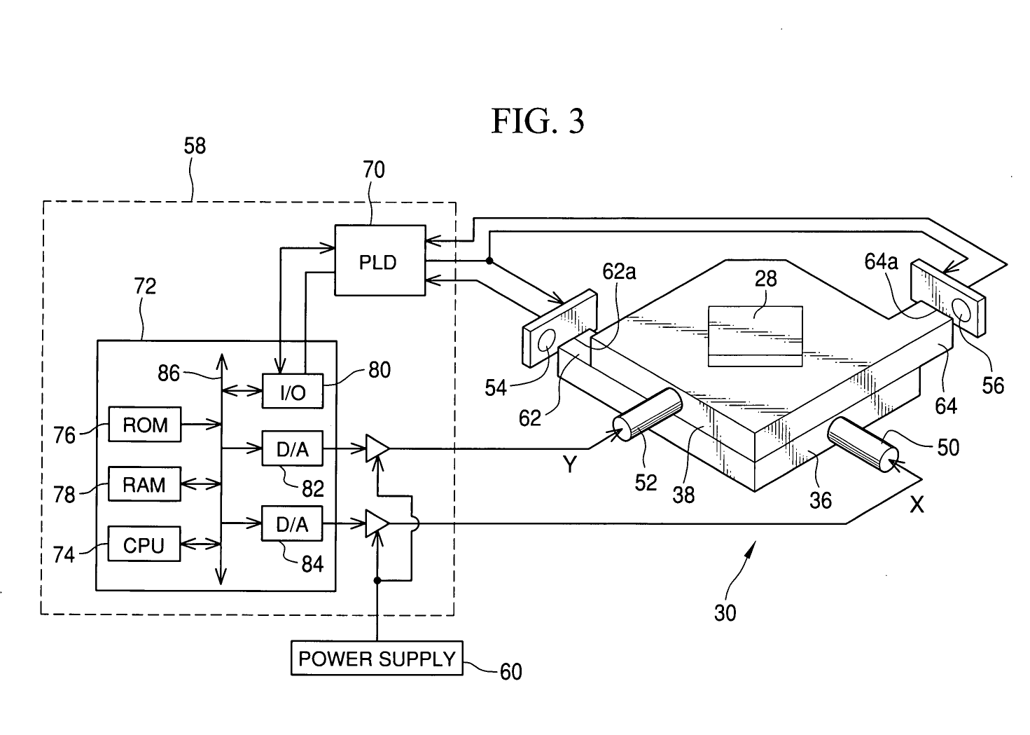

As shown in FIG. 3, the CCD moving mechanism 30 has the X-direction stage 36, the Y-direction stage 38, an X-direction piezo element 50, a Y-direction piezo element 52, an X-direction position sensor 54 and a Y-direction position sensor 56. These structural parts of the CCD moving mechanism 30 are mounted on the support plate 34 (see FIG. 1). In FIG. 3, the support plate 34 is not depicted for the purpose of simplifying the drawing. The X-direction piezo element 50 and the Y-direction piezo element 52 is expanded and contracted by the drive voltage that is output from a power source 60 and adjusted by a piezo driver 58. Thereby, the X-direction stage 36 and the Y-direction stage 38 respectively move in X direction and Y direction. Note that the X direction and the Y direction are perpendicular to each other.

The Y-direction stage 38 is placed above the X-direction stage 36, and the CCD image sensor 28 is attached to the upper surface of the Y-direction stage 38. When the X-direction stage 36 is moved in the X direction, the Y-direction stage 38 and the CCD image sensor 28 are moved in the X direction as well. The CCD image sensor 28, fixed on the Y-direction stage, is held in that the longitudinal direction thereof is kept at 45 degrees to the X direction and the Y direction, and thereby the alignment of the pixels of the CCD image sensor 28 corresponds to the X direction and the Y direction (see FIG. 2).

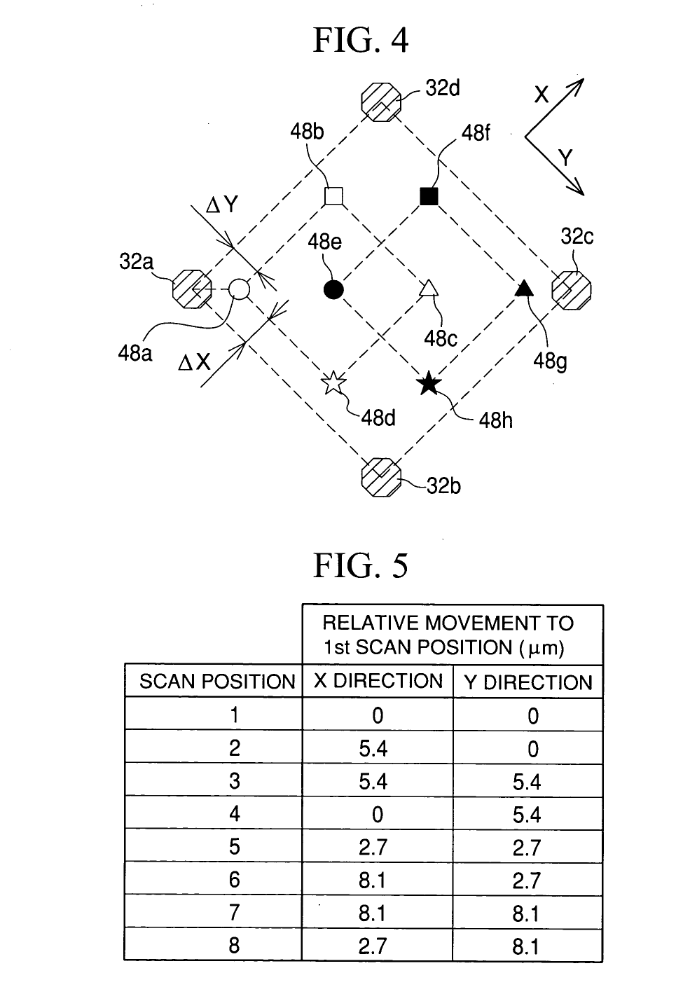

When the X-direction piezo element 50 and the Y-direction piezo element 52 are expanded or contracted, the CCD image sensor 28 moves in the X direction and the Y direction. As shown in FIG. 4, movement of the CCD image sensor 28 causes the pixel 32a to move in a rectangular area (shown by the dotted lines) defined by the pixel pitch (10.8 μm) in X direction and Y direction. The pixels 32b, 32c, 32d adjacent to the pixel 32a are also moved by the same amount. During the image scan operation, the pixel 32a is moved to the 1st scan position 48a (shown by the white circle), the 2nd scan position 48b (shown by the white rectangular), the 3rd scan position 48c (shown by the white triangle), the 4th scan position 48d (shown by the white star), the 5th scan position 48e (shown by the black circle), the 6th scan position 48f (shown by the black rectangular), the 7th scan position 48g (shown by the black triangle) and the 8th scan position 48h (shown by the black star). The CCD image sensor 28 scans the film image on the photo film 14 one by one at the 1st to 8th scan positions. The image data of eight frames are synthesized in the image synthesize circuit 45, and thereby it is possible to increase the resolution of the scanned image without increasing the pixels of the CCD image sensor 28.

The amount of expansion and contraction of the X-direction piezo element 50 and the Y-direction piezo element 52 (in other words, the movement of the CCD image sensor 28) is controlled by a piezo driver 58. Referring to FIG. 5, the 1st to 8th scan positions 48a-48h are different by the unit of quarter of the pixel pitch (10.8 μm). At the 1st position 48a, the piezo driver 58 supplies voltage to the piezo elements 50, 52 to shift the CCD image sensor 28 by 2.0 μm in the X and Y directions. Thus, the movement of the CCD image sensor 28 is controlled at all scan positions 48a-48h.

In FIG. 3, the metal X-direction stage 36 has a projected portion 62 extended in the X direction, and the front surface 62a of the projected portion 62 faces the X-direction position sensor 54. In addition, the Y-direction position sensor 56 faces a front surface 64b of a projected portion 64 that is integrated with the metal Y-direction stage 38.

The X-direction position sensor 54 has a two-dimensional spiral conductive material (inductor) formed on an insulation substrate, and a fixed capacitor having a predetermined capacity. With high frequency current from a high frequency power supply, an inductance is generated in the conductive material so that the conductive material is oscillated at a certain frequency by resonation with the fixed capacitor. When the front surface 62a of the metal projected portion 62 comes closer to the X-direction position sensor 54, induced current generated in the front surface 62a decreases the high frequency current in the conductive material. Then, inductance in the conductive material decreases, and as a result, the oscillation frequency increases.

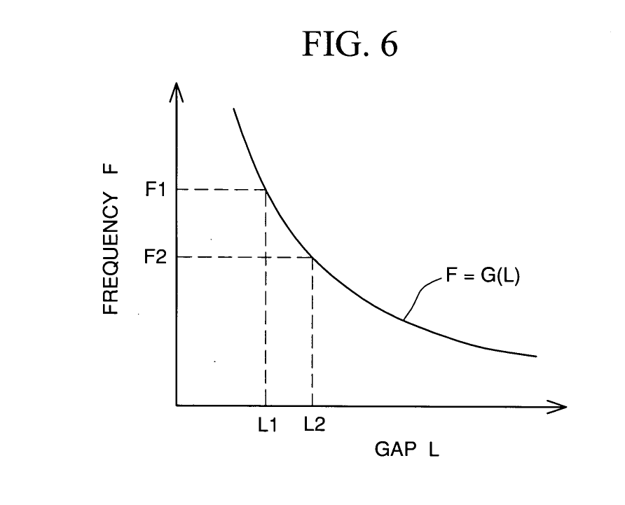

The approximate expression of the gap L between the position sensor 54 and the front surface 62a as the function of the oscillation frequency F is defined as L=G(F), as shown in FIG. 6. The information of the approximate expression is stored in a ROM 76 of the piezo driver 58 in the manufacture. Thus, the gap L is measured by detecting the oscillation frequency F. For example, in moving the CCD image sensor 28 in the X direction to change the gap L from L1 to L2 (see FIG. 6), the piezo driver 58 determines the target oscillation frequency F2 based on the approximate expression, and controls the output voltage to the X-direction piezo element 50 such that the oscillation frequency F reaches F2. Thereby, it is possible to control the movement of the X-direction stage 36. The structure and operation of the Y-direction position sensor 58 is the same as those of the X-direction position sensor 56.

Referring to FIG. 3, the piezo driver 58 has a PLD (Phase Logic Device) 70 and a controller 72. The PLD 70 sends frequency information from the X-direction position sensor 54 and the Y-direction position sensor 56 to the controller 72. The controller 72 adjusts the voltage to supply the X-direction piezo element 50 and the Y-direction piezo element 52 based on the frequency information (position information of the CCD image sensor 28).

The controller 72 has a CPU 74 to control the operation of the piezo driver 58, a ROM 76 to store the CCD movement control program, a RAM 78 as a work memory, an Input/Output (I/O) circuit 80 that is connected with the PLD 70, and a D/A converters 82, 84. These elements in the controller 72 are electrically connected by a data bus 86.

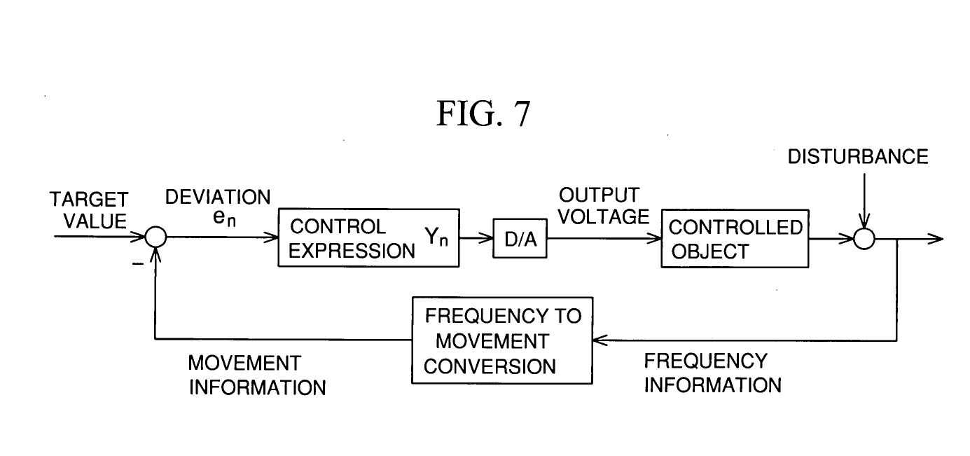

Following the PID feedback control system in FIG. 7, the controller 72 calculates the output voltage to the X-direction piezo element 50. For instance, the controller 72 calculates the output voltage according to the control expression Yₙ and supplies the calculated voltage to the X-direction piezo element 50 as the controlled object. In the following control expression Yₙ, the deviation eₙ is calculated by subtracting a target value of the movement from the measured value (position information from the X-direction position sensor 54). The frequency information detected by the X-direction position sensor 54 is converted into movement information. This movement information is used for feedback control to make the measured value close to the target value. This control expression is defined as follows:

$${Y}_{n} = K \{ {e}_{n} + \frac{θ}{{T}_{I}} {\sum }^{} {e}_{n} + \frac{{T}_{D}}{θ} ( {e}_{n} - {e}_{n - 1} ) \}$$

In the above expression, K is the parameter of proportional gain, T_{I} is the parameter of integral time, T_{D} is the parameter of differential time, and θ is the parameter of sampling time. By selecting the parameters appropriately, the piezo driver 58 can control the output voltage such that the movement of the X-direction stage 36 gradually changes toward the target value. The piezo driver 58 performs the same control operation to the Y-direction piezo element 52.

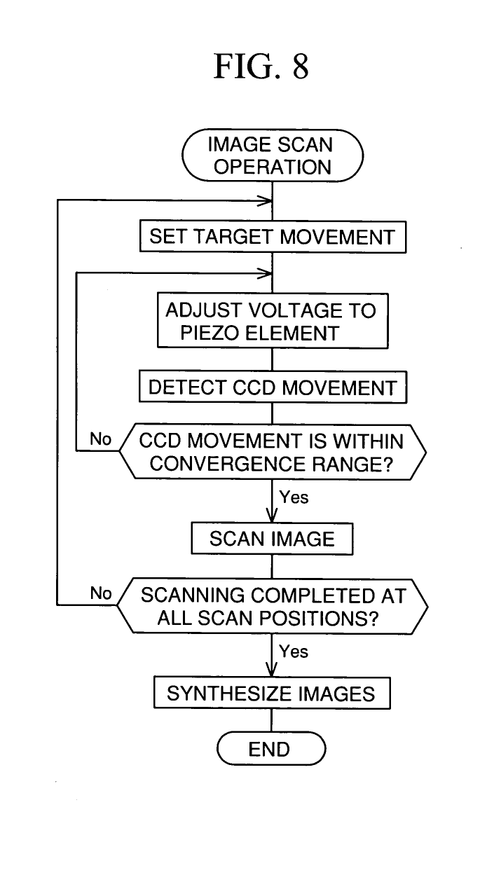

The image scan operation is described with reference to the flow chart of FIG. 8. In response to external operations by an operator to instruct the image scan operation, the piezo driver 58 drives the X-direction piezo element 50 and the Y-direction piezo element 52 to move the CCD image sensor 28 to the initial position (the 1st scan position 48a). The output voltage to the piezo elements 50, 52 is controlled at the initial position (1st scan position 48a), so the hysteresis of the piezo elements 50, 52 is not affected in scanning the image at the 1st scan position 48a.

After the image on the photo film 18 is scanned, the CCD image sensor 28 is moved to the next scan position (2nd position 48b, for example) to repeat to scan the image. The piezo driver 58 sets the target value of movement of the CCD image sensor 28 in the X and Y directions, and controls the output voltages to the X-direction piezo element 50 and the Y-direction piezo element 52 based on the above described control expression Yₙ. Then, the piezo driver 58 detects the movement of the CCD image sensor 28 based on the signals from the X-direction position sensor 54 and the Y-direction position sensor 56. If the difference between the target movement value and the actual movement is within a convergence range (±0.5 μm of the target movement value, for example), the CCD image sensor 28 starts to scan the image. These steps are repeated by plural times (eight times for example), and the image scan operation is completed when the image on the photo film 18 is scanned at all scan positions 48a-48h.

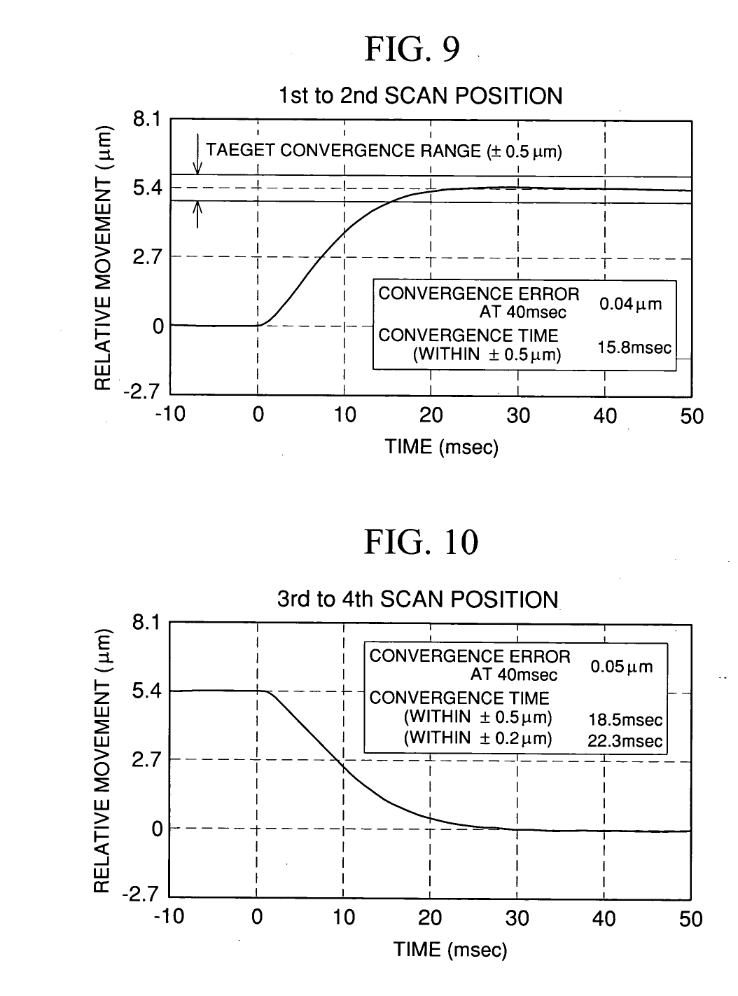

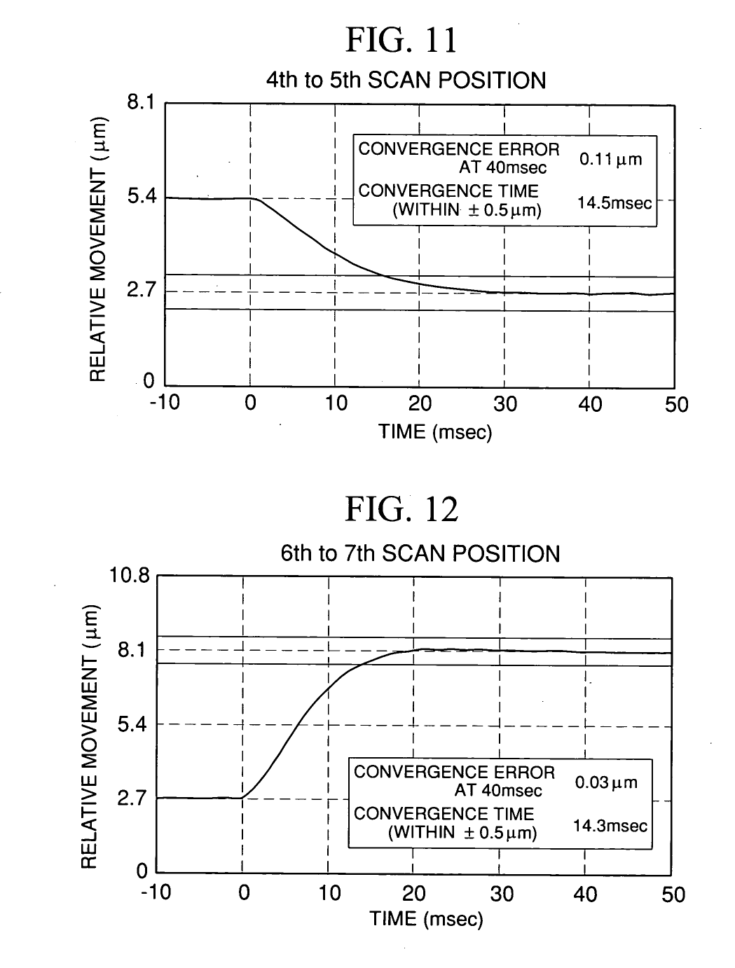

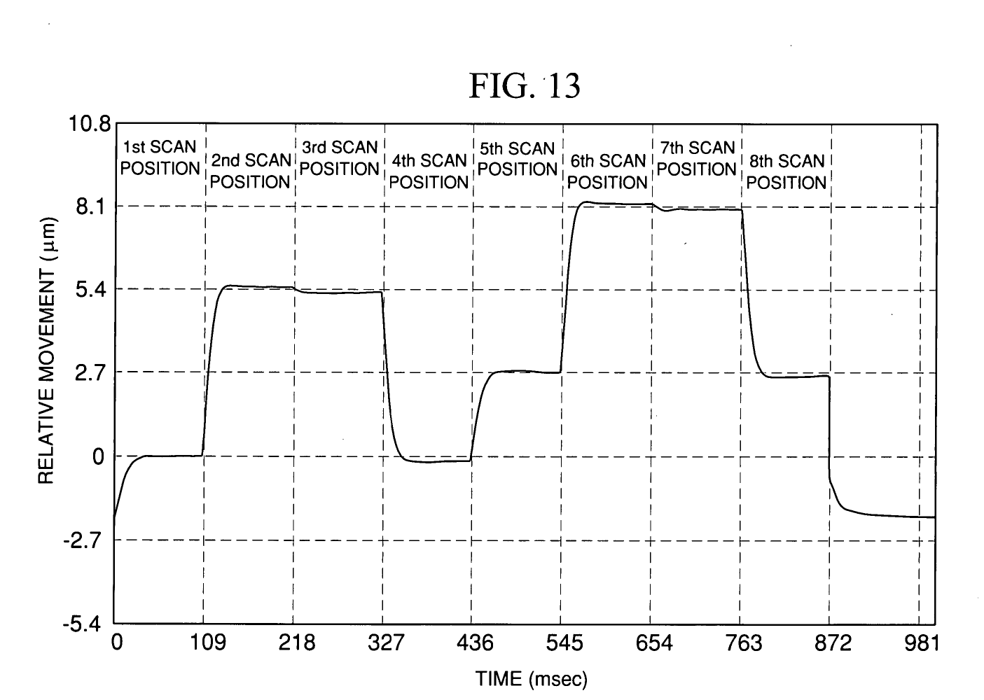

FIGS. 9-12 show examples of movement of the CCD image sensor 28 in the X direction by use of the movement control device. The movement in the Y direction is similar to the examples in FIGS. 9-12. FIG. 9 shows the example of movement from the 1st scan position 48a to the 2nd scan position 48b. The vertical axis in FIG. 9 indicates the relative movement to the 1st scan position 48a. A non-control position is defined as the position of the CCD image sensor 28 in which no output voltage is supplied to the X-direction piezo element 54. When the movement from the non-control position to the 1st scan position is 2.0 μm, the CCD image sensor 28 is moved by 7.4 μm (2.0+5.4 μm) at the 2nd position.

In FIG. 9, when the instruction to move the CCD image sensor 28 is generated at time 0, the piezo driver 58 starts to control the movement of the CCD image sensor 28 from the 1st scan position 48a to the 2nd scan position 48b. Since the movement of the CCD image sensor 28 gradually increases by the PID control, it is possible to prevent too much stress to the mechanical parts of the CCD movement device 30 (such as spring plates to press the X-direction stage 36 and the Y-direction stage 38 toward the initial positions). The relative movement of the CCD image sensor 28 gradually approaches the target value (5.4 μm), and converges within the target convergence range (5.4±0.5 μm). In the example of FIG. 9, the convergence time within ±0.5 μm range is short as 15.8 μsec, so the movement control device in this embodiment can carry out the pixel shift quickly. When the image scan start time is 40 msec, the convergence error of 0.04 μm at 40 msec makes it possible to perform sub-micron position control.

As shown in the graphs of FIGS. 10-12, the CCD moving mechanism 30 can move to other scan positions in a period as short as 15 msec and realize sub-micron convergence error at 40 msec. Therefore, it is possible to improve the quality of the scanned image obtained by pixel shift and plural image scanning.

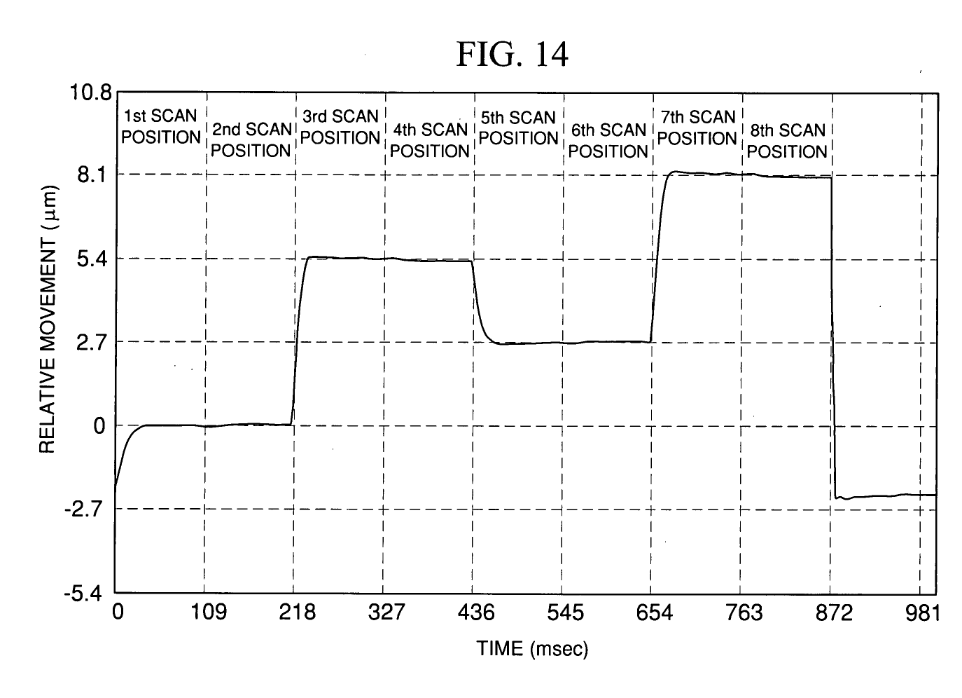

FIGS. 13 and 14 respectively show an example of the movement of the CCD image sensor 28 in the X and Y directions. In FIGS. 13, 14, the CCD image sensor 28 is moved continuously from the 1st scan position 48a to the 8th scan position 48h in the numerical order. The graphs in FIGS. 13 and 14 show that the feedback control of the movement at each scan position enables to repeat to control the movement without accumulating the error. When the piezo driver 58 does not carry out the movement control (before 0 sec and after 872 msec), the relative movement of the CCD image sensor 28 becomes negative (about −2.0 μm). This is because the piezo driver 58 outputs voltage to the X-direction piezo element 50 and the Y-direction piezo element 52 at the 1st scan position 48a as the initial position.

The target value in movement control is determined by detecting the position of the CCD image sensor 28 just before starting the movement control and setting the target value for the 1st to 8th scan positions 48a-48h based on the position information. Since the target value is determined by setting the relative movement on the basis of the detected position, it is possible to control the movement accurately between the scan positions even if the position of the CCD image sensor 28 is deviated after long-term use.

In the above embodiment, eight times of the image scan is carried out to scan the film image of one frame, the number of scanning may be changed according to the print size and needed image data size (image pixels). For instance, when two image scan is needed, the CCD image sensor 28 scans the film image at the 1st scan position 48a and the 3rd scan position 48c. When four image scan is needed, the CCD image sensor 28 is moved to the 1st to 4th scan positions 48a-48d for image scan. The order of the scan positions may be changed accordingly.

The curve of the movement of the CCD image sensor (see the graphs in FIGS. 9-12) may be changed as long as the start and the end of the movement are not too rapid. For instance, the curve of the movement of the CCD image sensor may form a sine curve.

Although the film image is scanned at predetermined 1st to 8th scan positions in the above embodiment, the target movement position may be slightly shifted in X and Y directions from the 1st to 8th scan positions as long as the image quality of the scanned image is not badly affected. In that case, since the pitch of the sampling positions becomes random, it is possible to prevent moire.

In the above embodiment, the pixels 32 of the CCD image sensor 28 are arranged in hound's-tooth check, but other types of the image sensor, such as a CCD image sensor having squarely latticed pixels, a CCD line sensor and a CMOS image sensor.

The mechanism to move the CCD image sensor 28 is not limited to the one in the above embodiment. For example, a ball bush mechanism may be used to guide the CCD image sensor 28. Although the position sensor in the above embodiment detects the change in the inductance, it is possible to use other types of the position sensor, such as an eddy current type proximity sensor and a laser displacement sensor. As for the drive source to move the CCD image sensor 28, a stepping motor may be used instead of the piezo element.

In the above embodiment, the movement control device is utilized in shifting the position of the CCD image sensor. The present invention is also applicable to the case in which the position of an object needs to be controlled with high precision. For example, the present invention is applicable to a stepper and an alignment apparatus for joining substrates.

Various changes and modifications are possible in the present invention and may be understood to be within the scope of the present invention.

1. A movement control apparatus for controlling the movement of a controlled object, the movement control apparatus comprising:
a movable stage on which the controlled object is supported;
a moving mechanism for moving the movable stage;
a position detecting device for detecting the position of the movable stage and outputting position information; and
a control device for setting target positions of the movable stage including an initial position and for controlling the movement of the movable stage such that the position information from the position detecting device becomes substantially the same as the target position.

2. The movement control apparatus according to claim 1, wherein the movable stage is movable in two directions that are perpendicular to each other.

3. The movement control apparatus according to claim 1, wherein the position detecting device is a position sensor that changes the output as the position information in accordance with the distance to the movable stage;
wherein the control device sets a target output as an output of the position sensor at the target position, and controls the movement of the movable stage such that the output from the position sensor comes closer to the target output.

4. The movement control apparatus according to claim 1, wherein the moving mechanism includes a piezo element.

5. An image scan apparatus for moving an imaging device to plural scan positions and generating image data by photoelectrically scanning an image on a recording medium at the scan positions, the image scan apparatus comprising:
a movable stage on which the imaging device is supported;
a moving mechanism for moving the movable stage;
a position detecting device for detecting the position of the movable stage and outputting position information; and
a control device for setting target positions of the movable stage corresponding to the scan positions and for controlling the movement of the movable stage such that the position information from the position detecting device becomes substantially the same as the target position.

6. The image scan apparatus according to claim 5, further comprising an image synthesizing section to synthesize the image data obtained by scanning the image at the scan positions.

7. The image scan apparatus according to claim 5, wherein the movable stage is movable in two directions that are perpendicular to each other and parallel to the photo receiving surface of the imaging device.

8. The image scan apparatus according to claim 5, wherein the scan positions includes an initial position to start to scan the image.

9. The image scan apparatus according to claim 5, wherein the scan positions are arranged at a same interval within a pixel pitch of the imaging device.

10. The image scan apparatus according to claim 5, wherein the scan positions are randomly shifted from the positions arranged at a same interval within a pixel pitch of the imaging device.

11. The image scan apparatus according to claim 5, wherein the position detecting device is a position sensor that changes the output as the position information in accordance with the distance to the movable stage;
wherein the control device sets a target output as an output of the position sensor at the target position, and controls the movement of the movable stage such that the output from the position sensor comes closer to the target output.

12. The image scan apparatus according to claim 5, wherein the moving mechanism includes a piezo element.

13. An image scanning method for moving an imaging device, supported on a movable stage, to plural scan positions and generating image data by photoelectrically scanning an image on a recording medium at the scan positions, the image scanning method comprising the steps of:
(a) setting target positions of the movable stage corresponding to the scan positions of the imaging device;
(b) driving a position detecting device to output the position information of the movable stage;
(c) controlling the movement of the movable stage such that the position information from the position detecting device becomes substantially the same as the target position;
(d) repeating the steps (b) and (c) until the position information is within a convergence range around the target position;
(e) driving the imaging device to scan the image on the recording medium; and
(f) repeating the steps (b) to (e) to scan the image at plural scan positions.

14. The image scanning method according to claim 13, further comprising the step of:
(g) synthesizing the image data obtained by image scanning at the plural scan positions.

15. The image scanning method according to claim 13, wherein the movable stage is movable in two directions that are perpendicular to each other.

16. The image scanning method according to claim 13, wherein the scan positions includes an initial position to start to scan the image.

17. The image scanning method according to claim 13, wherein the scan positions are arranged at a same interval within a pixel pitch of the imaging device.

18. The image scanning method according to claim 13, wherein the scan positions are randomly shifted from the positions arranged at a same interval within a pixel pitch of the imaging device.
